(19) United States
(12) Patent Application Publication
(10) Pub. No.: US 2013/0256240 A1
(43) Pub. Date: Oct. 3, 2013

(54) DEVICE AND METHOD FOR FILTERING FLUIDS

(71) Applicant: Ulrich Sander, Worms (DE)

(72) Inventor: Ulrich Sander, Worms (DE)

(73) Assignee: KHS GmbH, Dortmund (DE)

(21) Appl. No.: 13/993,904

(22) PCT Filed: Nov. 16, 2011
(86) PCT No.: PCT/EP2011/005757

§ 371 Date: Jun. 13, 2013

(30) Foreign Application Priority Data
Dec. 22, 2010 (DE) 10 2010 055 522.3

(51) Int. Cl. B01D 37/04

(52) U.S. Cl. CPC B01D 37/04
USPC 210/767; 210/198.1; 210/323.1; 210/97

(57) ABSTRACT

An apparatus for filtration of fluids includes a filtration tank having an unfiltered-fluid chamber, an inlet for unfiltered fluid, a filtered-fluid chamber, an outlet for filtered fluid, and a gas barrier. The gas barrier includes either the filtered-fluid chamber or the gas outlet.

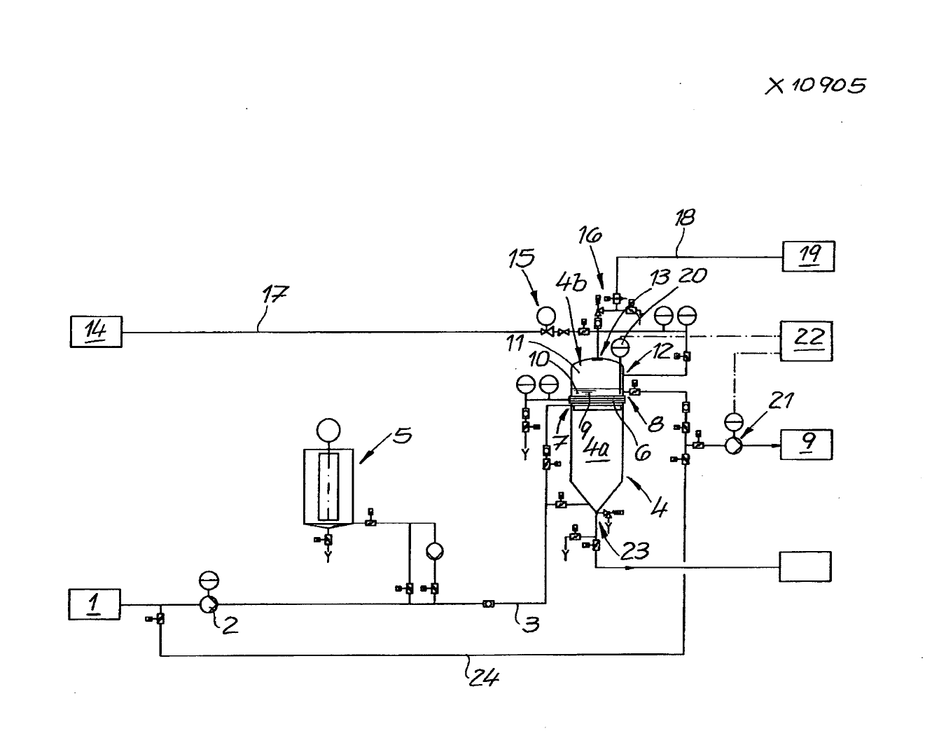

The invention relates to a device for filtering fluids, in particular a filtering device for drinks such as beer, with at least one filtration tank with an unfiltered-fluid chamber having an inlet for unfiltered fluid and a filtered-fluid chamber having an outlet for filtered fluid.

In the filtering of fluids and in particular drinks such as beer, so-called precoat filtration is typically used. To this end, the filtration tank is provided, which is subdivided by a dividing plate or a dividing wall in the unfiltered-fluid chamber and the filtered-fluid chamber. Filter cartridges generally hang on the dividing wall or dividing plate into the unfiltered-fluid chamber.

The unfiltered fluid is fed to the unfiltered-fluid chamber, runs though a precoat layer forming on or at the filter cartridges and is filtered during this operation. The filtered unfiltered fluid then reaches the filtered-fluid chamber as filtered fluid. This operation can be supported by pumps for example and/or be triggered in this way. To form the precoat layer, a filter aid such as kieselguhr is generally added to the drink to be filtered, here being in particular beer. After passing though the precoat layer, the thus filtered drink reaches the filtered-fluid chamber and here can be removed and drawn off as filtered fluid.

In the generic prior art according to EP 1 250 948 B1, a filtration tank of this kind is made. In addition, a holding tank upstream of the filtration tank is provided for unfiltered fluid and a holding tank downstream of the filtration tank for filtered fluid. These are in each case buffer tanks which are provided before and after the actual precoat filter inside the filtration tank. This plant design is primarily due to the fact that precoat filtration is a sensitive process and that, because of the buffer tank, flow and pressure fluctuations are decoupled from the precoat filter.

The holding tank for unfiltered fluid upstream of the filtration tank generally ensures that the unfiltered fluid is mixed and experiences a volume buffering. Moreover, in this way, if necessary, the reaction time or filter time inside the filtration tank can be increased. Holding tanks of this kind for unfiltered fluid are designed to be relatively voluminous for the reasons described.

In contrast, a simplified functionality is assigned to the holding tank for filtered fluid, i.e. a buffer tank downstream of the filtration tank. In fact, this buffer tank downstream generally ensures that the pressure of the filtered fluid is kept largely constant in the outlet. i.e. the buffer tank provided at this point ensures that despite fluctuating geodesic pressure of the filtered fluid at the outlet of the filtered-fluid chamber, no or only insignificant pressure fluctuations are to be found.

Furthermore, the buffer tank downstream of the filtration tank ensures that the filtered fluid extracted is typically subject to the necessary counter-pressure which prevents degasification. In this regard, it must be known that drinks containing CO₂ such as beer for example and the solubility of CO₂ in the product concerned are dependent on the temperature and the pressure of the drink in the example case. For this reason, the so-called release of CO₂ from the drink must be prevented. This means that the filtered fluid provided for a subsequent filling operation must generally be subject to a pressure which stands at around 1 bar (0.1 MPa) above the saturation pressure of CO₂ in the example case. This pressure or counter-pressure is provided inter alia by the buffer tank downstream of the filtration tank and prevents the previously mentioned degasification or carbon dioxide release at or in the outlet for the filtrate.

Quite regardless of this, with the help of such buffer tanks in the outlet of a filtration tank, perfect filtration results are achieved. For in the outlet, there are often powerful pumps which without an interposed buffer tank can lead to damage to the precoat filter layer forming in the filter tank.

The technical plant structure with the buffer tank before and after the precoat filter in accordance with EP 1 250 948 B1 is however enormous and needs improvement in the plant implementation against the backdrop of increasing price pressure. This applies even where additional installations to attenuate pressure hammering are in each case proposed in the context of DE 197 06 578 T2 or also according to EP 1 485 215 B1. For these installations are generally used in addition to the buffer tanks according to EP 1 250 948 B1 and further increase the input in terms of plant and process engineering. The invention is intended to provide a remedy here.

The invention resolves the technical problem of further developing a device of this kind for the filtration of fluids so that the technical plant cost is reduced and a simplification of the process is observed. Moreover, a correspondingly suitable method for the operation of such a device is to be specified.

To resolve this technical problem is a generic device in the context of the invention characterised in that the filtered-fluid chamber in the filtration tank and/or the connected outlet is/are also designed as a gas buffer.

In the context of the invention, the filtration chamber thus takes on so to speak a double or multiple function. Firstly, it ensures as normal that the unfiltered fluid passing through one filter and in particular a precoat filter is stored as filtered fluid and can be drawn off from the filtered-fluid chamber via an outlet. Furthermore, the filtered-fluid chamber functions as it were as a downstream buffer tank or takes on the function of the holding tank for the filtered fluid or the buffer tank normally provided at this point, as already described in detail with regard to EP 1 250 948 B1.

To this end, the filtered-fluid chamber and possibly the outlet are volumetrically composed of a filtered-fluid volume and a gas buffer volume. The filtrate volume is designed and dimensioned here so that the filtered-fluid chamber can store sufficient filtered fluid inside the filtration tank so that the volume of the external buffer tank for the filtered-fluid, said tank being downstream of the filtration tank in accordance with EP 1 250 948 B1, is so to speak shifted into the filtration tank or the filtered-fluid chamber.

A further feature is that the filtered-fluid chamber and/or the outlet connected to the filtered-fluid chamber function as a gas buffer and in this connection ensure that the drink and in particular beer is given the necessary counter-pressure in the filtered-fluid chamber so that the previously described degasification or carbon dioxide release is prevented. In general, to this end, the pressure of the gas buffer in the treatment of beer is set so that it stands at around 1 bar (0.1 MPa) above the CO₂ saturation pressure of the beer in the example case. To this end, the gas or buffer gas of the gas buffer can be set to a specified pressure, for example the already mentioned pressure inside the filtered-fluid chamber and/or outlet of 1 bar above the saturation pressure of the drink to be treated, in the example case beer.

To implement this structurally, the filtered-fluid chamber typically has, in addition to the outlet for the filtered fluid, at least one gas connection for the gas supply/gas removal of the buffer gas concerned to produce the gas buffer. In the treatment of drinks containing CO₂ such as beer for example, CO₂ is used as a buffer gas. Basically, other gases too and here in particular inert gases are naturally covered by the invention. Here, inert gas in the context of the invention means an inert gas which does not react with the treated fluids or drinks.

In actual fact, in general two or more gas connections are provided, namely at least one gas inlet into and at least one gas outlet from the filtered-fluid chamber. The gas buffer forming or pre-existing inside the filtered-fluid chamber is generally disposed above the filtered fluid in the filtered-fluid chamber concerned. For this reason, at least the gas outlet is located on the top of the filtration tank. To this end, the filtration tank is fitted with a filtration dome which is volumetrically larger than the prior art and otherwise conventionally produced, in the area of the filtered-fluid chamber. This filtration dome has two or more gas connections, namely the gas inlet just above a dividing wall between the unfiltered-fluid chamber and the filtered-fluid chamber, and the gas outlet on the top of the filtration dome.

To create similar conditions in the filtered-fluid chamber, correspondingly modified according to the invention, of the filtration tank as in the saved additional buffer tank downstream of the filtered-fluid chamber, a gas pressure setting device is provided to set the gas pressure of the gas buffer. In fact, this gas pressure setting device ensures, as already described, that the gas pressure stands at for example 1 bar (0.1 MPa) above the saturation pressure for CO₂ dissolved in beer, this being where CO₂ is used as the buffer gas. The setting of the gas pressure occurs in the sense of a control.

To this end, the gas pressure setting device is advantageously fitted with a pressure reducing valve and a pressure back-up valve. The pressure reducing valve is generally located in the gas inlet whereas the pressure back-up valve is provided in the gas outlet. In this regard, the pressure reducing valve may ensure that the gas or CO₂ in the example case is supplied to the gas inlet at a certain minimum pressure. With the help of the pressure back-up valve, on the other hand, the maximum pressure, observed in the filtered-fluid chamber, of the buffer gas is specified.

Moreover, in addition to the gas pressure setting device, a fluid-level setting device is advantageously provided, with the help of which the filtered-fluid level in the filtered-fluid chamber can be set. The filtered-fluid level too is generally specified and set in the meaning of a control. In fact, the fluid level of the filtered fluid in the filtered-fluid chamber is controlled at a specified level.

To achieve this in detail, the fluid-level setting device is composed of a fluid-level sensor and a filtered-fluid pump. With the help of the fluid-level sensor, the fluid level inside the filtered-fluid chamber is retrieved. The filtered-fluid pump ensures that the filtered fluid is drawn out of the filtered-fluid chamber via the outlet. The filtered-fluid pump is preferably a frequency-controlled centrifugal pump.

With the help of a control unit, fluid can be admitted to this frequency-controlled centrifugal pump or generally the filtered-fluid pump such that, depending on the values determined by the fluid-level sensor for the fluid level, the filtered-fluid pump ensures the managed or controlled emptying of the filtered-fluid chamber. In any event, with the help of the control unit in the filtered-fluid chamber, the filling level can be set and observed.

Moreover, the control unit may of course basically also be set up and provided so that with its help the gas pressure setting device ensures the necessary gas pressure of the buffer gas in the filtered-fluid chamber. Here, the gas pressure of the buffer gas is set or controlled at a value specified by the control unit.

As a result, a device for the filtration of fluids and a method for the filtration of such fluids are described, which firstly are characterised by a reduced technical plant cost. As a consequence of this, clearly lower investment costs are to be expected in the implementation. Moreover, the shift of the function of the buffer tank for filtered fluid located downstream of the filtration tank quasi into the filtration tank leads to the space requirement being reduced compared with conventional installations.

As a further consequence and resulting advantage, a reduced maintenance requirement is observed. Finally, the course of the operation is simplified as the buffer quantity needed for the filtered fluid is so to speak made available in the filtrate tank and at the same time the filtrate tank or its filtered-fluid chamber ensures that the fluid to be treated, in the example case the drink containing CO₂, is subject to the necessary counter-pressure. This counter-pressure is above the CO₂ saturation pressure in the example case of beer. A further advantage to be taken into account is that, according to the invention, not only can the filtered-fluid chamber as such take on the described functions but additionally the outlet is also available as an additional store for the filtered fluid and/or the buffer gas. I.e. the compressible volume of the buffer gas can if needed be extended affordably and structurally. The main advantages are to be found here.

Below the invention is described in more detail by means of a drawing illustrating just one example of an embodiment. The only FIGURE shows schematically a device for the filtration of fluids.

A device for the filtration of fluids is illustrated in the FIGURE. The fluids to be treated are, in the example of an embodiment, drinks containing CO₂ and in particular beer. This beer is, as unfiltered fluid 1, supplied to the device to be described in detail below. For this, a pump 2 is provided in a supply line 3 to a filtration tank 4. A dosing device 5 is connected to the supply line 3 to the filtration tank 4. With the help of dosing device 5, a filtration aid, for example kieselguhr, is dosed to the unfiltered fluid 1 in the known way and manner. In this regard, reference is made to the previously mentioned EP 1 250 948 B1.

The unfiltered fluid 1 reaches, via the supply pipe 3, an unfiltered-fluid chamber 4a of the filtration tank 4. The unfiltered-fluid chamber 4a is separated from a filtered-fluid 4b by a dividing wall 6. On the dividing wall 6, not expressly described filter cartridges may hang into the unfiltered-fluid chamber 4a and furthermore serve as a support surface for the filtration aid discharging at it or onto it and for the formation of a precoat filter layer.

In any case, the unfiltered fluid 1 must first reach the unfiltered-fluid chamber 4a via an inlet 7 and pass through the filter cartridges found in there or generally one filter to finally reach the filtered-fluid chamber 4b as a filtered drink in the example case or filtered fluid 9. From the filtered-fluid chamber 4b, the filtered fluid 9 is drawn off via an outlet 8.

The filtered-fluid chamber 4b has an overall bigger volume in comparison with the filtration tanks 4 used hitherto. This is due to the filtered-fluid chamber 4b taking on, on the one hand, the function of a buffer tank in the prior art typically found in outlet 8, for the filtered fluid 9 and, on the other hand, functioning as a gas buffer or additionally having a gas buffer inside it. I.e. the filtered-fluid chamber 4b is composed volumetrically of a filtered fluid volume 10 indicated in the FIGURE and additionally a gas buffer volume 11. To this end, the filtered-fluid chamber 4b is fitted with, in addition to the outlet 8 for the filtered fluid 9, two additional gas connections 12, 13 in the example case.

In fact, a gas inlet 12 is connected above the dividing wall 6 to the filtered-fluid chamber 4b. Via this gas inlet 12, a buffer gas 14—in the example case CO₂—reaches the filtered-fluid chamber 4b and fills up the gas buffer volume. In addition to the gas inlet 12, a gas outlet 13 is also additionally provided on the filtered-fluid chamber 4b. Due to the lower specific weight, the gas buffer volume 11 is disposed above the filtrate volume 10. The gas outlet 13 is on the top of the filtration tank 4 or the top of a filter dome defining the filtered-fluid chamber 4b.

In fact, the filtration tank 4 may be constructed overall in two parts and in the example of an embodiment comprises a bottom section housing the unfiltered-fluid chamber 4a and the previously mentioned filter dome defining the filtered-fluid chamber 4b. The bottom section and the filter dome are connected to each other by means of the dividing wall 6. This is naturally only to be understood as an example and is not limiting.

With the help of a gas pressure setting device 15, 16, the gas pressure of the buffer gas 14 inside the filtered-fluid chamber 4b or the gas pressure of the gas buffer volume 11 can be set. To this end, the gas pressure setting device 15, 16 is composed of a pressure reducing valve 15 in a supply pipe 17 of the buffer gas 14 to the filtered-fluid chamber 4b and additionally a pressure back-up valve 16 in a derivation 18 for the buffer gas 14. At the end of the derivation 18 with the pressure back-up valve 16 in it, a device 19 can be provided for the recovery of the buffer gas 14. In any event, the two valves 15, 16 ensure that the buffer gas 14 inside the filtered-fluid chamber 4b or the pressure of the gas buffer volume 11 is set to a specified value and held at this value.

In the example of an embodiment, which is not limiting, the pressure reducing valve 15 in the supply pipe 17 is designed for the buffer gas such that it is supplied at a pressure of more than 1.5 bar (0.15 MPa). The pressure back-up valve 16 ensures that the pressure in the gas buffer volume 11 is held below 1.8 bar (0.18 MPa) so that the pressure of the buffer gas 14 and consequently the outlet pressure of the filtered fluid 9 is held at values in a range between 1.5 and 1.8 bar (0.15 MPa and 0.18 MPa). These details are naturally only to be understood as an example and are not constraining. Overall, the issue is that the pressure of the buffer gas 14 inside the filtered-fluid chamber 4b stands above the saturation pressure of the drink to be treated, in the case of the example, to avoid a degasification.

In addition to this gas pressure setting device 15, 16, a fluid-level setting device 20, 21, 22 is also provided. The fluid-level setting device 20, 21, 22 basically has a fluid-level sensor 20 and a filtered-fluid pump 21.

The fluid-level sensor 20 measures the filled level of the filtered fluid 9 in the filtered-fluid chamber 4b and the filtered-fluid volume 10. In contrast, the filtered-fluid pump 21 ensures that the filtered-fluid chamber 4b is emptied via the outlet 8. The fluid-level sensor 20 and the filtered-fluid pump 21 are jointly connected to a control unit 22. The filtered-fluid pump 21 is appropriately controlled depending on the values determined by the fluid-level sensor 20 for the filled level of the filtered fluid 9 in the filtered-fluid chamber 4b. The filtered-fluid pump 21 is, in the example of an embodiment, a frequency-controlled centrifugal pump 21 so that the control unit 22 specifies the pump delivery rate of the filtered-fluid pump 21 via the frequency.

Here, the design is overall made such that the fluid level of the filtered fluid 9 and consequently the filtered-fluid volume 10 are controlled at a specified filling level or a specified volume. This occurs with the help of the control circuit made up of the fluid-level sensor 20, the filtered-fluid pump 21 and finally the control unit 22.

Basically, the gas pressure setting device 15, 16 can also be connected to the control unit 22. The control unit 22 then ensures additionally that with the help of the gas pressure setting device 15, 16, the gas pressure of the gas buffer or the buffer gas 14 inside the filtered-fluid chamber 4b is set or controlled at a certain value specified by the control unit 22.

At the bottom end of the filtered-fluid chamber 4a, an outlet 23 can be seen via which sludge accumulating on the filter cartridges or the filter generally can be removed. This sludge can possibly be treated. It is furthermore possible to return filtered fluid 9 to the supply pipe 3 via a recirculation pipe if the filtered fluid 9 does not meet requirements for example regarding turbidity.

1-15. (canceled)

16. An apparatus for filtration of fluids, said apparatus comprising a filtration tank comprising an unfiltered-fluid chamber, an inlet for unfiltered fluid, a filtered-fluid chamber, an outlet for filtered fluid, and a gas barrier, wherein said gas barrier comprises at least one of said filtered-fluid chamber and said outlet.

17. The apparatus of claim 16, wherein said filtered-fluid chamber comprises a filtered-fluid volume and a gas buffer volume.

18. The apparatus of claim 16, wherein said filtered-fluid chamber and said outlet comprise a filtered-fluid volume and a gas buffer volume.

19. The apparatus of claim 16, wherein said filtered-fluid chamber further comprises a gas connection to a supply of buffer gas.

20. The apparatus of claim 19, wherein said gas connection is connected to a supply of carbon dioxide.

21. The apparatus of claim 19, wherein said gas connection is connected to a supply of an inert gas.

22. The apparatus of claim 16, wherein said filtered-fluid chamber comprises a gas inlet and a gas outlet.

23. The apparatus of claim 16, wherein said gas buffer is disposed above said filtered fluid in said filtered-fluid chamber.

24. The apparatus of claim 16, further comprising a gas-pressure setting device configured to set a gas pressure for said gas buffer.

25. The apparatus of claim 24, further comprising a controller configured to cause said gas pressure to be maintained.

26. The apparatus of claim 24, wherein said gas-pressure setting device comprises a pressure reducing valve and a pressure back-up valve.

27. The apparatus of claim 16, further comprising a fluid-level setting device for setting a filtered-fluid level in said filtered-fluid chamber.

28. The apparatus of claim 27, wherein said filtered-fluid setting device comprises a fluid-level sensor and a filtered-fluid pump.

29. The apparatus of claim 28, wherein said filtered-fluid pump comprises a frequency-controlled centrifugal pump.

30. The apparatus of claim 27, further comprising a control unit configured to maintain said filtered-fluid level in said filtered-fluid chamber.

31. A method of filtering fluid, said method comprising operating the apparatus recited in claim 16, wherein operating said apparatus comprises supplying an unfiltered fluid to said unfiltered fluid-chamber via said inlet, and drawing off filtered fluid from said filtered-fluid chamber using said outlet, wherein said filtered fluid is obtained by filtering said unfiltered fluid, and forming a gas buffer, wherein forming a gas buffer comprises supplying buffer gas to one of said filtered-fluid chamber and said outlet in addition to filtered fluid.

32. The method of claim 32, further comprising setting said buffer gas to be at a specified pressure inside one of said filtered-fluid chamber and said outlet.

33. The method of claim 32, further comprising setting a fluid level of said filtered fluid to a specified filling level.
